(19) United States
(12) Patent Application Publication
(10) Pub. No.: US 2007/0241862 A1
(43) Pub. Date: Oct. 18, 2007

(54) Transponder authorization system and method

(76) Inventors: Steven J. Dimig, Plymouth, WI (US); Michael G. Feucht, Menomonee Falls, WI (US); Abdel Salah, Rochester Hills, MI (US); Erik Esser, Milwaukee, WI (US); Alan J. Ritz, Brookfield, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 11/402,618

(22) Filed: Apr. 12, 2006

(51) Int. Cl. G05B 19/00

(52) U.S. Cl. 340/5.62; 340/5.72; 307/10.5; 340/10.1

(57) ABSTRACT

A transponder authorization system and method. The transponder authorization system can include an operator device having a transponder and an antenna coupled to a powersports vehicle. The antenna can generate a field. The transponder authorization system can also include an authorization system electrically connected to the antenna and an ignition switch. The transponder authorization system can also include a button coupled to the ignition switch. The button can be pushed by an operator to actuate the ignition switch. The transponder can receive and transmit a signal when in the presence of the field. The authorization system can verify the signal in order to start the powersports vehicle.

### BACKGROUND OF THE INVENTION

Powersports vehicles, such as all-terrain vehicles, snowmobiles, motorcycles, boats, and personal water craft, generally include ignition systems operated by a key only or a key and a start button. These ignition systems require the operator to always remove the key in order to keep the powersports vehicle secure from theft. However, the operators of powersports vehicles often leave the key in the ignition cylinder so that the powersports vehicle can be quickly started and stopped, which results in the powersports vehicle often not being secure from theft. Powersports vehicles typically have simple mechanical ignition locks which are subject to tampering and can readily be defeated by a thief. In addition, the wiring harness from the ignition switch is typically exposed allowing it to be readily attacked compromising the security of the vehicle.

### SUMMARY OF THE INVENTION

Some embodiments of the invention provide a transponder authorization system for use with an ignition system of a powersports vehicle. The transponder authorization system can include an operator device having a transponder and an antenna coupled to the powersports vehicle. The antenna can generate a field. The transponder authorization system can also include an authorization system electrically connected to the antenna and an ignition switch. The transponder authorization system can also include a button coupled to the ignition switch. The transponder can receive and transmit a signal when in the presence of the field. When an operator presses the button, the authorization system can verify the signal in order to start the powersports vehicle.

Embodiments of the invention provide a method of starting a powersports vehicle. The method can include positioning an operator device including a transponder within a field generated by an antenna coupled to the powersports vehicle. The method can also include pushing a button, actuating an ignition switch, transmitting a signal to and from the transponder when in the presence of the field, and verifying the signal, in order to start the powersports vehicle.

Other aspects of the invention will become apparent by consideration of the detailed description and accompanying drawings.

### BRIEF DESCRIPTION OF THE DRAWINGS

FIG. 1 is a schematic illustration of a transponder authorization system according to one embodiment of the invention.

FIG. 2 is an exploded perspective view of a fob, a button, a mounting bracket, and a switch assembly for use with the transponder authorization system of FIG. 1.

FIGS. 3A and 3B are a perspective view and a cross-sectional view of the fob, the button, the mounting bracket, and the switch assembly of FIG. 2.

FIGS. 4A and 4B are a perspective view and a cross-sectional view of the fob, the button, the mounting bracket, and the switch assembly of FIGS. 2 and 3 with the fob stored in the mounting bracket.

FIG. 5 is a perspective view of the mounting bracket of FIGS. 2-4.

FIG. 6 is a perspective view of the switch assembly of FIGS. 2-4 including an antenna.

FIG. 7 is a perspective view of a switch for use in the switch assembly of FIGS. 2-4 and 6.

FIG. 8 is an electrical schematic illustration of a control circuit for use with the transponder authorization system and an all-terrain vehicle according to one embodiment of the invention.

FIG. 9 is a perspective of a glove for use as an operator device.

FIG. 10 is a schematic illustration of a transponder authorization system according to another embodiment of the invention.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

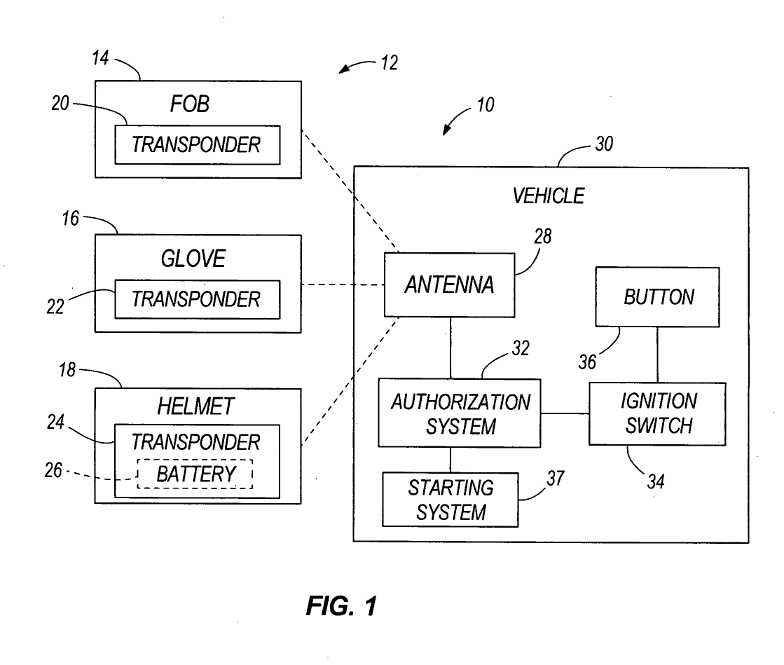

FIG. 1 illustrates a transponder authorization system 10 according to one embodiment of the invention. The transponder authorization system 10 can include an operator device 12, such as a fob 14, a glove 16, a helmet 18, or another article of clothing (e.g., a shirt, a jacket, a pair of pants, a ring). In some embodiments, the fob 14 can be a bladeless fob including a non-powered transponder 20. In some embodiments, the glove 16 can include a non-powered transponder 22 that can be placed in one of the fingers of the glove 16 or attached to a suitable inner or outer portion of the glove 16. The transponders 20 and 22 can receive and transmit a signal when in the presence of the appropriate field. The transponders 20 and 22 can be non-powered, because the fob 14 or the glove 16 can be positioned within inches of an antenna 28 coupled to a portion of a powersports vehicle 30.

In one embodiment, the helmet 18 can include a powered transponder 24 connected to a battery 26. The battery 26 can be used to power the transponder 24 so that the transponder 24 can receive and transmit a signal over a greater distance in order to increase the range of the transponder 24. For example, the transponder 24 can be powered, because the helmet 18 being worn by the operator may only come within several feet of the antenna 28 coupled to a portion of the powersports vehicle 30. However, any one of the transponders included in the operator devices 12 can be powered by a suitable battery in order to increase the range of the transponder.

The antenna 28 of the transponder authorization system 10 can be coupled to a suitable portion of the powersports vehicle, such as being coupled to a cylinder coupled to the handle bars. As shown schematically in FIG. 1, the antenna 28 can be electrically connected to an authorization system 32. The authorization system 32 can be electrically connected to an ignition switch 34. A button 36 can be coupled to the ignition switch 34. The button 36 can be coupled to a suitable portion of the powersports vehicle 30 so that an operator can press or move the button 36 to start the powersports vehicle 30. For example, the button 36 can be coupled to the handle bars In other embodiments, the ignition switch 34 can be incorporated into a throttle lever, or the ignition switch 34 can be incorporated into a brake lever. The authorization system 32 can be electrically connected to the vehicle starting system 37, which can include a motor, a solenoid, and/or a battery, in some embodiments.

The transponder authorization system 10 of FIG. 1 can generally operate as follows. The operator can press the button 36 which can actuate the ignition switch 34. The ignition switch 34 can trigger the authorization system 32 to send a signal to the antenna 28. The antenna 28 can generate a RF field. Any one of the transponders 20, 22, 24 can receive and transmit a signal when in the presence of the field. The antenna 28 can receive the response signal from the transponders 20, 22, 24 and can send a signal to the authorization system 32. The authorization system 32 can verify the signal. If the signal is verified, the authorization system 32 can send an output signal to the vehicle starting system 37 in order to start the powersports vehicle.

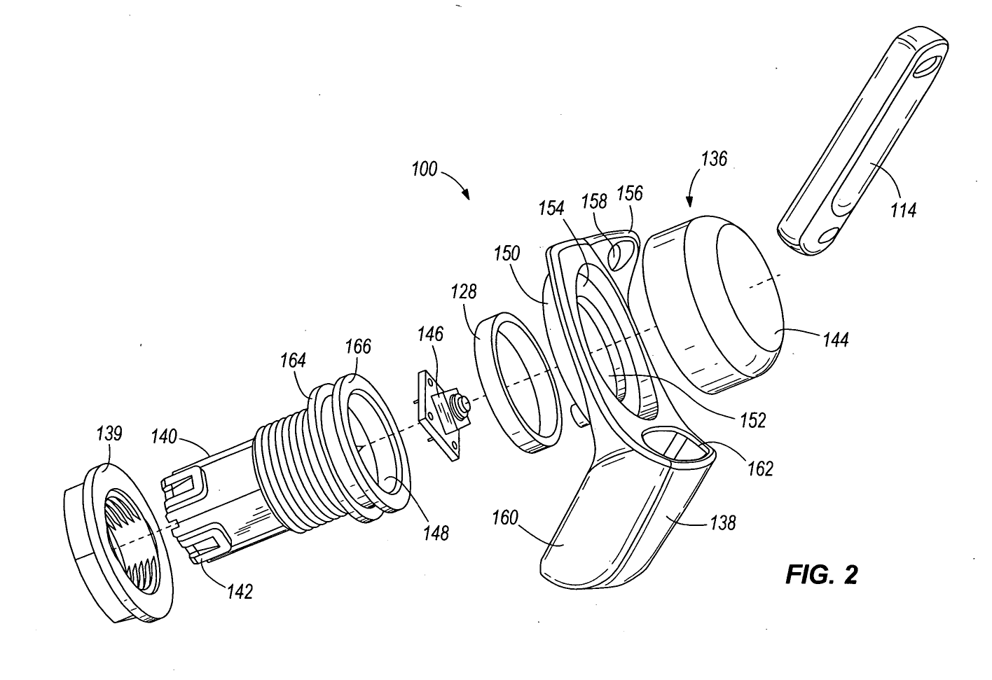

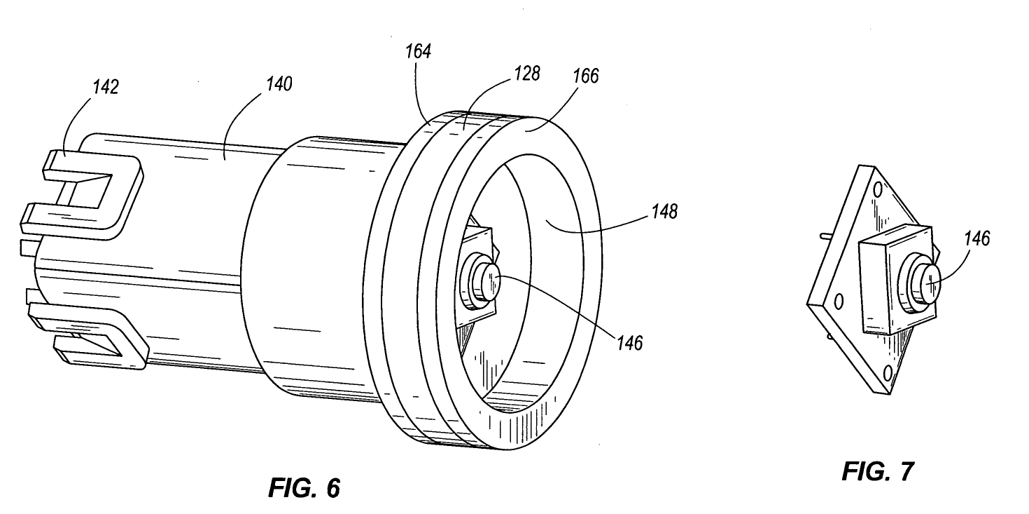

FIGS. 2-7 illustrate a transponder authorization system 100 according to one embodiment of the invention. As shown in FIGS. 2-4, the transponder authorization system 100 can include a fob 114 (including a transponder 120), a button 136, a mounting bracket 138, a mounting ring 139, a cylinder 140, and a switch assembly 142. The button 136 can include a flexible cover 144 (e.g., constructed of urethane). However, in other embodiments, the cover 144 can be constructed of a rigid material. As shown in FIG. 6 with the mounting bracket 138 and the cover 144 removed, an antenna 128 can be wrapped around a portion of the cylinder 140. As also shown in FIG. 6, the switch assembly 142 can include a switch 146 that can be positioned within a recessed portion 148 of the cylinder 140. The switch 146 can be positioned under the flexible cover 144 so that the switch 146 can be actuated when the operator contacts the flexible cover 144. The switch 146 can be electrically and/or mechanically coupled to the switch assembly 142.

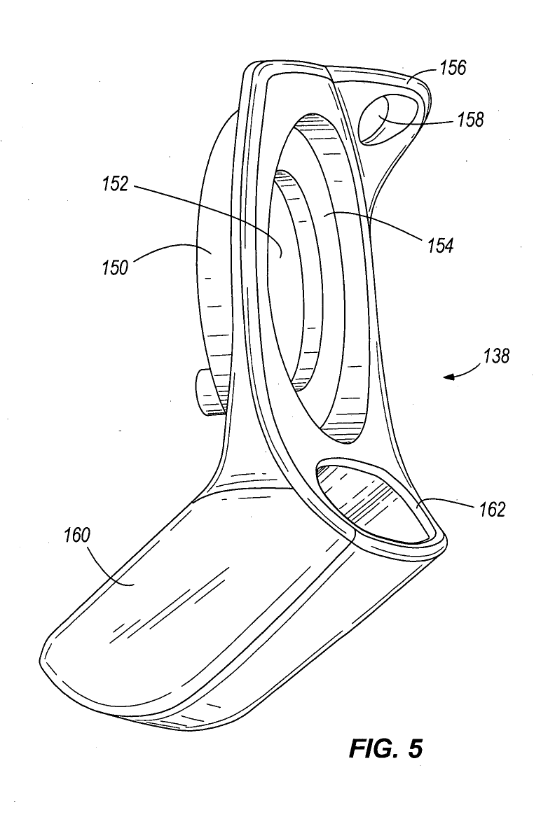

As shown in FIG. 5, the mounting bracket 138 can include an annular wall 150, a first aperture 152, a recessed portion 154, a tab 156, a second aperture 158, an extension 160, and a pocket 162. The annular wall 150 and the recessed portion 154 can be positioned around a portion of the cylinder 140, so that the aperture 152 can receive the switch 146. As shown in FIG. 6, the cylinder 140 can include an inner annular wall 164 and an outer annular wall 166 between which the antenna 128 can be positioned. The annular wall 150 and the recessed portion 154 of the mounting bracket 138 can be positioned behind the inner annular wall 164 of the cylinder 140. As shown in FIGS. 2-4, the annular wall 150 can be secured between the mounting ring 139 and the inner annular wall 164 of the cylinder 140. In some embodiments, the mounting ring 139 can be coupled to the cylinder 140 using a threaded engagement. The flexible cover 144 (as shown in FIGS. 2-4) can be wrapped around the antenna 128, the inner annular wall 164, and the outer annular wall 166 in order to cover the switch 146.

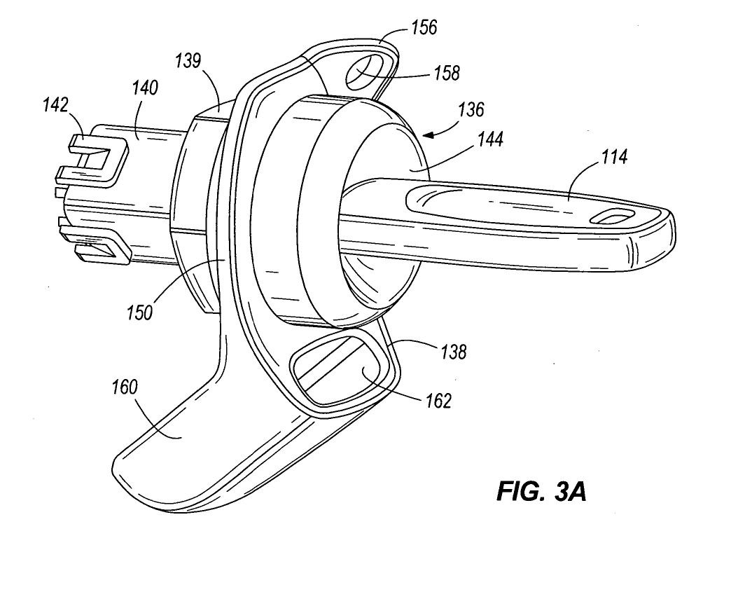

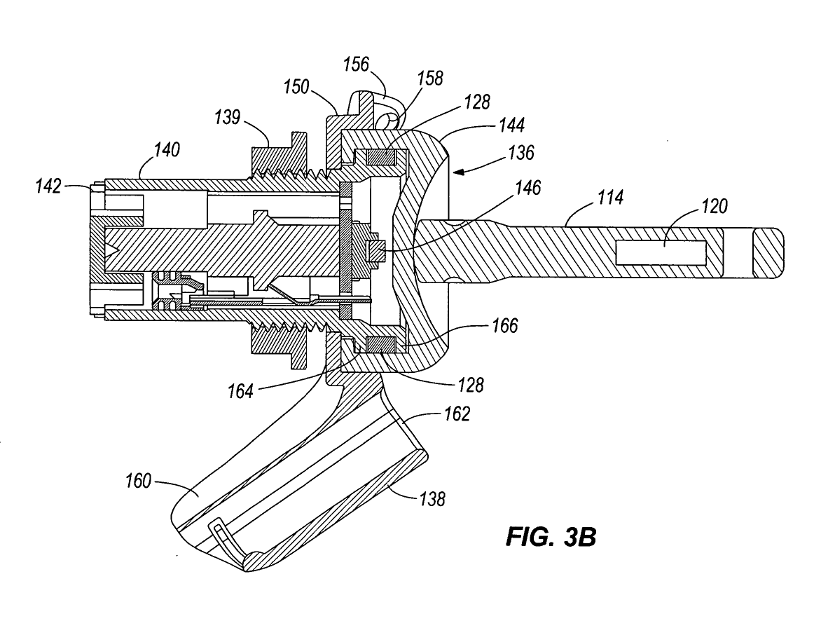

As shown in FIGS. 3A and 3B, an operator can press the fob 114 against the cover 144 of the button 136. In this position, the fob 114 is within the field being generated by the antenna 128, and the transponder 120 of the fob 114 can receive and transmit a signal. When the operator presses the fob 114 against the button 136, the cover 144 can flex to actuate the switch 146 in order to start the vehicle (if the signal from the fob 114 has been verified). Alternatively, the operator can hold the fob 114 in close proximity to the antenna 128 (in order for the transponder 120 to be within the field) and can then press the button 136 with his finger.

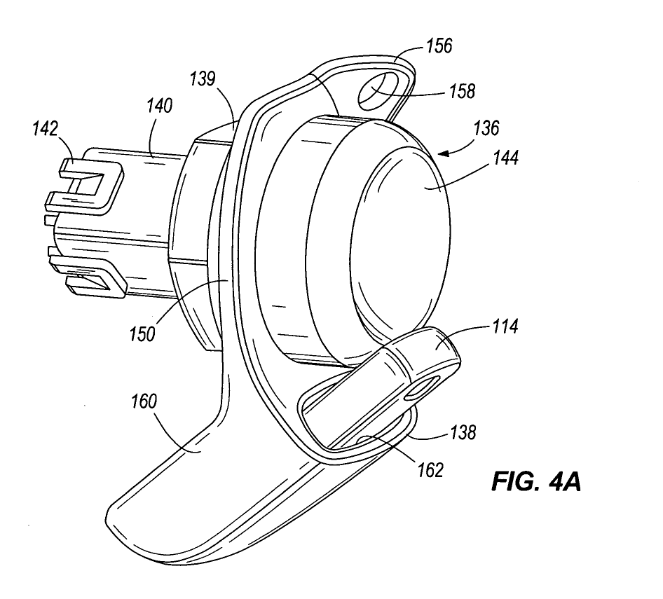

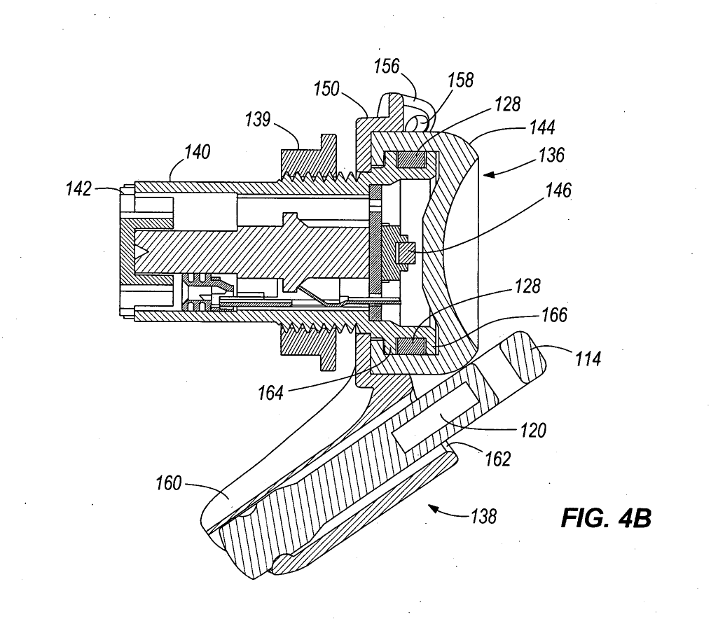

As shown in FIGS. 4A and 4B, the extension 160 of the mounting bracket 138 can form an angle (e.g., about 135 degrees, in one embodiment) with respect to a plane of the annular wall 150 and the aperture 152. The extension 160 can rest against or be coupled to a portion of the powersports vehicle, such as the handle bars. The extension 160 and pocket 162 can provide a second method to start and operate the powersports vehicle. The operator begins the starting sequence by inserting the fob 114 into the pocket 162. The operator then presses the button 136 which mechanically actuates the ignition switch 146. The ignition switch 146 triggers the authorization system 32 to send a signal to the antenna 128. The antenna 128 can generate a radio frequency field. The transponder 120 can receive and transmit a signal when in the presence of the field. The antenna 128 receives the response signal from the transponder 120 and sends a signal to the authorization system 32. The authorization system 32 can verify the signal. If the signal is verified, the authorization system 32 can send an output signal to the vehicle starting system in order to start the powersports vehicle. As shown in FIGS. 4A and 4B, the pocket 162 can be deep enough to hold the fob 114 during operation of the powersports vehicle, but shallow enough so that a portion of the fob 114 can extend outside of the pocket 162 for easy removal.

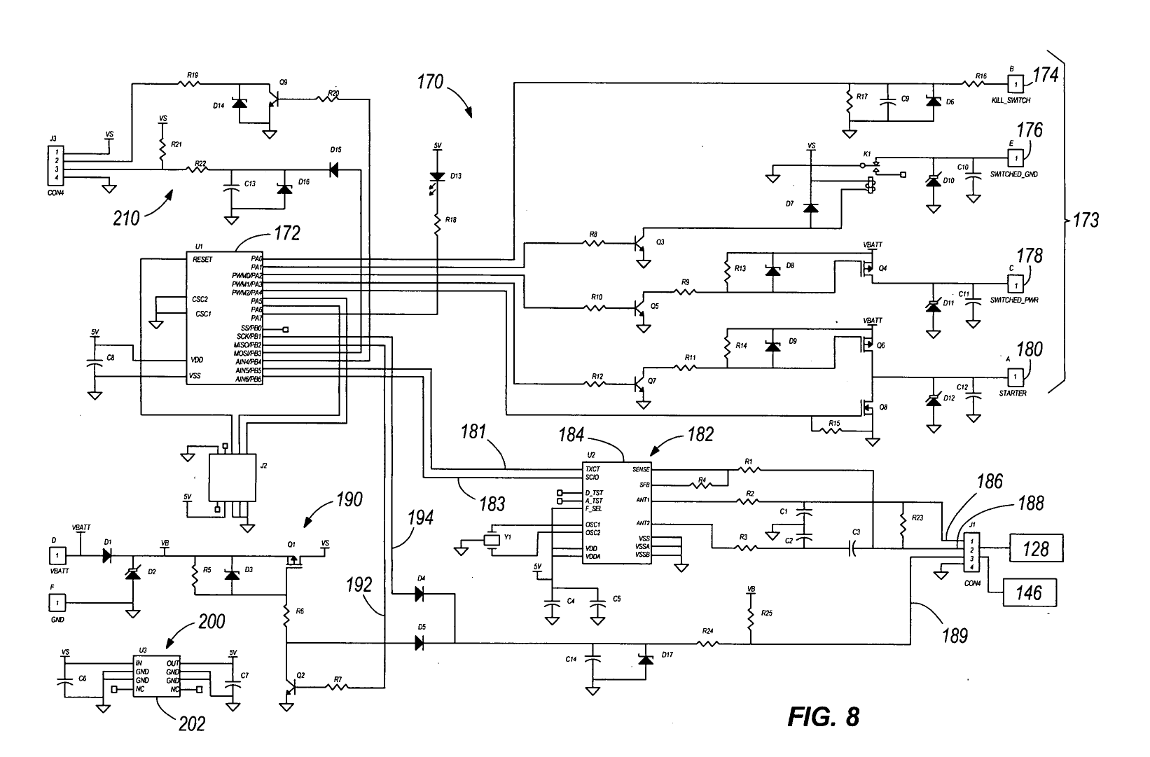

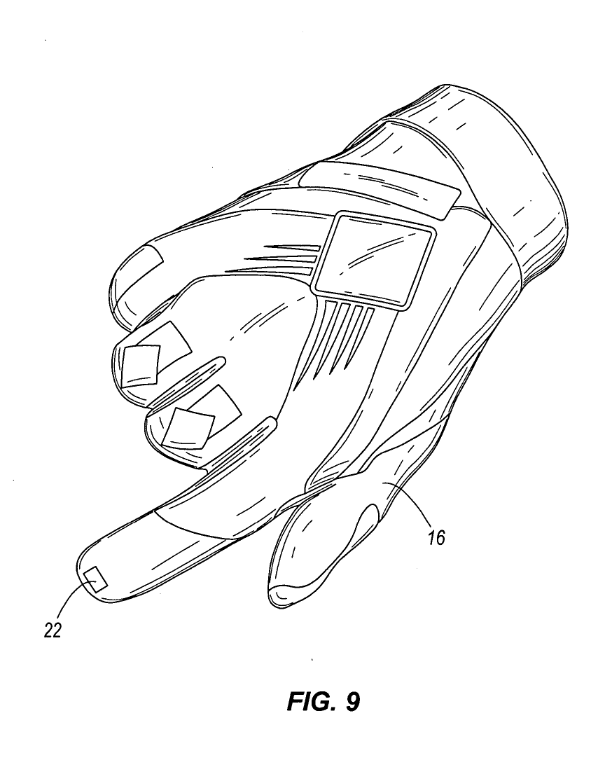

FIG. 8 schematically illustrates a control circuit 170 that can be included in the authorization system 32 of the transponder authorization system 100. The control circuit 170 is designed for use with an all-terrain vehicle. The control circuit 170 can be included in a module or housing that can be coupled to a portion of the all-terrain vehicle's frame. For example, the module or housing can be coupled to an underside or interior portion of the all-terrain vehicle's frame so that the module or housing cannot be easily tampered with. In some embodiments, the control circuit 170 can be used to replace an existing or factory ignition switch for the all-terrain vehicle. The control circuit 170 can include a main processor 172 connected to several connectors 173, including a kill switch connector 174, a switch ground connector 176, a switch power connector 178, and a starter connector 180. The existing or factory ignition switch can be removed and the connectors 173 can be connected to the all-terrain vehicle's starting system (which can include a motor, a solenoid, and/or a battery).

The kill switch 174 can be connected to resistors R16 and R17, a capacitor C9, and a diode D6. The switch ground connector 176 can be connected to a resistor R8, a transistor Q3, diodes D7 and D10, a relay K1, and a capacitor C10. The relay K1 can be connected to the ignition coil of the powersports vehicle to ensure that the ignition coil is grounded when the powersports vehicle is not in use. The switch power connector 178 can be connected to resistors R9, R10, and R13, transistors Q4 and Q5, diodes D8 and D11, and a capacitor C11. The starter connector 180 can be connected to resistors R11, R12, R14, and R15, transistors Q6, Q7, and Q8, diodes D9 and D12, and a capacitor C12. The transistors Q4, Q6, and Q8 can control power to the starting system of the powersports vehicle.

The main processor 172 can be connected to a transceiver circuit 182, which can include a transceiver 184 connected to the antenna 128 via connections 186 and 188 and a wiring harness. The wiring harness for the powersports vehicle can be connected to a connector J1. The transceiver circuit 182 can cause the antenna 128 to generate the appropriate field to energize the transponder 120 of the fob 114 or other operator device. The transceiver circuit 182 can also receive the signal transmitted by the transponder 120 of the fob 114 or other operator device. Connected between the transceiver 184 and the connections 186 and 188, the transceiver circuit 182 can include resistors R1, R2, R3, R4, and R23, and capacitors C1, C2, and C3. The transceiver circuit 182 can be connected to the main processor 172 in order to transmit a radio frequency identification (RFID) signal (via a connection 181) and in order to receive a RFID signal (via a connection 183). The switch 146 can be connected to the main processor 172 by the connection 189, a diode D4, and a connection 194 in order to provide a wake-up signal to the main processor 172 when the switch 146 is actuated.

The control circuit 170 can also include a voltage source circuit 200 in order to convert the voltage source VS into a 5-Volt signal for the main processor 172. The voltage source circuit 200 can include an integrated circuit 202 and capacitors C6 and C7.

The main processor 172, the transceiver circuit 182, and the voltage source circuit can be connected to a power latching circuit 190. The power latching circuit 190 can disconnect battery power from electronic components within the control circuit 170 in order to eliminate battery drain while the system is idle. The power latching circuit 190 can be connected to the switch 146 via a connection 189 and the wiring harness. The power latching circuit 190 can include resistors R5 and R6, diodes D1, D2, and D3, and transistors Q1 and Q2. The transistor Q2, the resistor R7, and a connection 192 can be used to latch the power on for the control circuit 170 after the switch 146 has been actuated.

Once the battery circuit 190 is activated and the engine is started, the transistor Q2 and the resistor R7 can provide a latching circuit to latch the power on for the control circuit 172 as long as the control circuit 172 remains in the same state (e.g., until the switch 146 is actuated again or the kill switch is actuated).

In some embodiments, the control circuit 170 can include an additional switch circuit 210 that can be used to program the main processor 172 or can be used for testing. The additional switch circuit 210 can also be used to connect a LED indicator to the control circuit 170. In some embodiments, the additional switch circuit 210 can be used to connect a safety interlock system to the control circuit (e.g., a switch that requires the operator to be seated before starting the engine).

In one embodiment, the control circuit 170 can generally operate as follows. Before the operator presses the button 136, the control circuit 170 can be drawing essentially no power from the battery of the powersports vehicle. An operator can press the button 136 (with the fob 114, with his finger, or with the finger of a glove including a transponder) in order to actuate the switch 146. A wake-up signal from the switch 146 can activate the power latching circuit 190. This can turn on power to the main processor 172 and the transceiver circuit 182 via the voltage source circuit 200. The wake-up signal can be transmitted to the main processor 172 via the connection 189, the diode D4, and the connection 194. The main processor 172 can de-bounce the wake-up signal to determine whether it is valid and latch the power latching circuit 190 in the on state. This process can keep the control circuit 170 powered up when the switch 146 is released.

Once the wake-up signal is received, the main processor 172 can transmit a RFID signal via the connection 181 to the transceiver circuit 182 and to the antenna 128 via the connection 186 and the wiring harness. The antenna 128 can generate a RF field. The RF field can energize the transponder 120 of the fob 114 or other operator device, if the transponder 120 is within range of the antenna's field (e.g., if the fob 114 is pressed against the button 136, if the fob 114 is stored in the mounting bracket 139, or if a transponder is otherwise within the range of the antenna 128). The energized transponder 120 can transmit a RFID signal with an identification code that can be received by the antenna 128. The RFID signal with the identification code can be transmitted back to the main processor 172 via the connection 188, the transceiver circuit 182, and the connection 183. The main processor 172 can determine whether the identification code matches the vehicle's authorized code as stored in memory of the main processor 172 or as stored in memory connected to the main processor 172.

If the identification code matches the vehicle's authorized code, the main processor 172 can determine whether the switch 146 is still actuated. If the switch 146 is still actuated, the main processor 172 can cause the transistors Q4, Q6, and Q8 to provide power to the switch ground connector 176 and the starter connector 180 in order to activate the vehicle starting system and to keep the engine turning until the engine starts. Once the engine starts and the operator releases the switch 146, the starter connector 180 can be grounded and the switch power connector 178 can be activated or powered. The control circuit 170 can remain in this state while the engine is running until the switch 146 is actuated again or the kill switch (connected to the kill switch connector 174) is actuated.

FIG. 9 illustrates one embodiment of a glove 16 that can include a transponder 22. The glove 16 can be used as the operator device, as described above. In some embodiments, the transponder 22 is not powered.

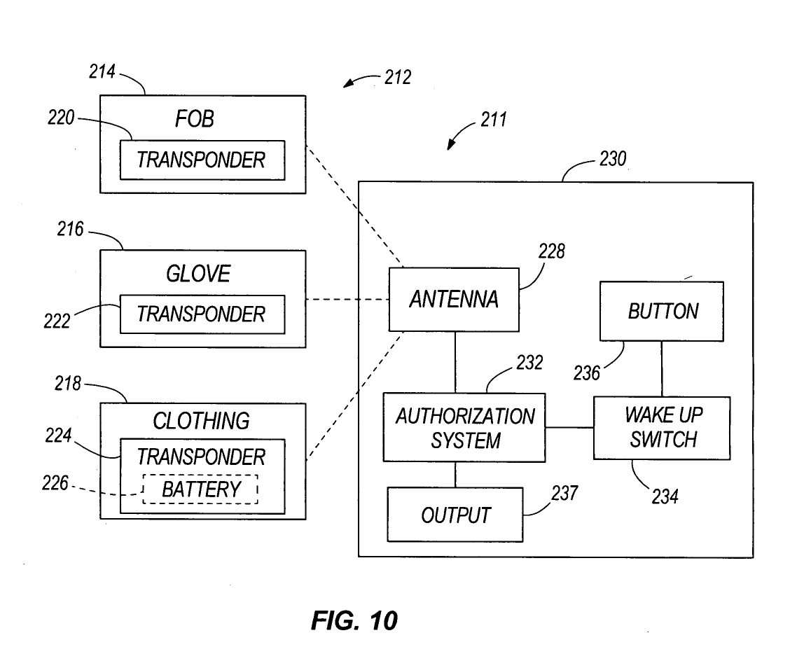

Although some embodiments of the invention have been described with respect to powersports vehicles, other embodiments of the invention can also be used with construction machinery (e.g., forklifts and loaders), lawn & garden equipment or with storage facilities (e.g., sports lockers, storage lockers, and storage sheds). FIG. 10 illustrates a transponder authorization system 211 according to another embodiment of the invention. The transponder authorization system 211 can include an operator device 212, such as a fob 214, a glove 216, or another article of clothing 218 (e.g., a shirt, a jacket, a pair of pants, a ring). In some embodiments, the fob 214 can be a bladeless fob including a non-powered transponder 220. In some embodiments, the glove 216 can include a non-powered transponder 222 that can be placed in one of the fingers of the glove 216 or attached to a suitable inner or outer portion of the glove 216. The transponders 220 and 222 can receive and transmit a signal when in the presence of the appropriate field. The transponders 220 and 222 can be non-powered, because the fob 214 or the glove 216 can be positioned within inches of an antenna 228 coupled to a portion of machinery, equipment, or a storage facility 230.

In one embodiment, the clothing 218 can include a powered transponder 224 connected to a battery 226. The battery 226 can be used to power the transponder 224 so that the transponder 224 can receive and transmit a signal over a greater distance in order to increase the range of the transponder 224. For example, the transponder 224 can be powered, because the clothing 218 being worn by the operator may only come within several feet of the antenna 228 coupled to a portion of the machinery, equipment, or storage facility 230. However, any one of the transponders included in the operator devices 212 can be powered by a suitable battery in order to increase the range of the transponder.

The antenna 228 of the transponder authorization system 211 can be coupled to a suitable portion of machinery, equipment, or storage facility, such as being coupled to a cylinder coupled to an instrument panel or door. As shown schematically in FIG. 10, the antenna 228 can be electrically connected to an authorization system 232. The authorization system 232 can be electrically connected to a wake-up switch 234. A button 236 can be coupled to the wake-up switch 234. The button 236 can be coupled to a suitable portion of the machinery, equipment, or storage facility 230 so that an operator can press or move the button 236 to operate the machinery or equipment or to open the storage facility. The authorization system 232 can be electrically connected to an output 237, which can include a latch, a motor, a solenoid, and/or a battery, in some embodiments.

The transponder authorization system 211 of FIG. 10 can generally operate as follows. The operator can press the button 236 which can actuate the wake-up switch 234. The wake-up switch 234 can trigger the authorization system 232 to send a signal to the antenna 228. The antenna 228 can generate a RF field. Any one of the transponders 220, 222, 224 can receive and transmit a signal when in the presence of the field. The antenna 228 can receive the response signal from the transponders 220, 222, 224 and can send a signal to the authorization system 232. The authorization system 232 can verify the signal. If the signal is verified, the authorization system 232 can send an output signal to the output 237 in order to start the machinery or equipment or in order to open a latch.

Various features and advantages of the invention are set forth in the following claims.

1. A transponder authorization system for use with a starting system of a powersports vehicle, the transponder authorization system comprising:
an operator device including a transponder;
an ignition switch coupled to the powersports vehicle;
an antenna coupled to the powersports vehicle;
an authorization system electrically connected to the antenna and the ignition switch; and
a button coupled to the ignition switch;
the button actuating the ignition switch when pushed by an operator, the authorization system sending a signal to the antenna, the antenna generating a field, the transponder receiving and transmitting a signal when in the presence of the field, and the authorization system verifying the signal in order to start the powersports vehicle.

2. The system of claim 1 wherein the operator device includes one of a fob, a glove, a helmet, an article of clothing, and a ring.

3. The system of claim 1 wherein the operator device includes a battery to power the transponder for a longer range of use from the antenna.

4. The system of claim 1 wherein the antenna includes a coil wrapped around a cylinder coupled to the button.

5. The system of claim 1 and further comprising a mounting bracket coupled adjacent to the button in order to store an operator device including a bladeless fob.

6. The system of claim 1 wherein the ignition switch is coupled to one of a throttle lever and a brake lever.

7. The system of claim 6 wherein the ignition switch is used to start an engine of the powersports vehicle and a kill switch is used to stop the engine of the powersports vehicle.

8. The system of claim 1 and further comprising a safety interlock device coupled to a seat of the powersports vehicle and electrically connected to the ignition switch.

9. The system of claim 1 wherein the powersports vehicle is one of an all-terrain vehicle, a snowmobile, a personal water craft, a boat, a motorcycle, a construction machine, and a lawn mower.

10. The system of claim 1 wherein the authorization system is not powered before the ignition switch is actuated, is powered when the ignition switch is actuated, and remains powered after the ignition switch is released until a change of state.

11. A method of starting a powersports vehicle, the method comprising:
positioning an operator device with a transponder within a range of an antenna coupled to a powersports vehicle;
pushing a button to actuate the ignition switch;
generating a field from the antenna;
receiving and transmitting a signal from the transponder in the presence of the field; and
verifying the signal in order to start the powersports vehicle.

12. The method of claim 11 and further comprising wearing the operator device in one of a fob, a glove, a helmet, an article of clothing, and a ring.

13. The method of claim 11 and further comprising increasing the range of the transponder by providing battery power to the transponder.

14. The method of claim 11 and further comprising pushing the button by actuating a switch under a cover.

15. The method of claim 11 and further comprising storing a bladeless fob in a mounting bracket coupled adjacent to the button.

16. The method of claim 11 and further comprising pressing one of a throttle lever and a brake lever to push the ignition switch.

17. The method of claim 16 and further comprising actuating the ignition switch to start an engine of the powersports vehicle and pushing a kill switch to stop the engine of the powersports vehicle.

18. The method of claim 11 and further comprising activating a safety interlock device by sitting on a seat of the powersports vehicle.

19. The system of claim 11 wherein the signal is verified by an authorization system, and further comprising not powering the authorization system before the ignition switch is actuated, powering the authorization system when the ignition switch is actuated, and continuing to power the authorization system after the ignition switch is released until a change of state.

20. A transponder authorization system for use with a starting system of a powersports vehicle, the transponder authorization system comprising:
an operator device including a transponder;
an ignition switch, a button, an antenna, and a mounting bracket coupled to the powersports vehicle; and
an authorization system electrically connected to the antenna and the ignition switch;
the mounting bracket receiving the operator device in order to position the transponder within a field of the antenna, the button actuating the ignition switch when pushed by an operator, the authorization system sending a signal to the antenna, the antenna generating the field, the transponder receiving and transmitting a signal when in the presence of the field, and the authorization system verifying the signal in order to start the powersports vehicle.

21. The system of claim 20 wherein the operator device includes a bladeless fob.

22. The system of claim 20 wherein the antenna includes a coil wrapped around a cylinder coupled to the button.

23. The system of claim 20 wherein the ignition switch is used to start an engine of the powersports vehicle and a kill switch is used to stop the engine of the powersports vehicle.

24. The system of claim 20 and further comprising a safety interlock device coupled to a seat of the powersports vehicle and electrically connected to the ignition switch.

25. The system of claim 20 wherein the powersports vehicle is one of an all-terrain vehicle, a snowmobile, a personal water craft, a boat, a motorcycle, a construction machine, and a lawn mower.

26. The system of claim 20 wherein the mounting bracket includes an extension and the extension includes a pocket to receive a bladeless fob.

27. The system of claim 20 wherein the authorization system is not powered before the ignition switch is actuated, is powered when the ignition switch is actuated, and remains powered after the ignition switch is released until a change of state.

28. An ignition system for use with an operator device including a transponder and a starting system of a powersports vehicle, the ignition system comprising:
an ignition switch, a button, and an antenna coupled to the powersports vehicle; and
an authorization system electrically connected to the antenna and the ignition switch;
the button actuating the ignition switch when pushed by an operator, the authorization system sending a signal to the antenna, the antenna generating the field, and the authorization system verifying a signal from the transponder in order to start the powersports vehicle.

29. The system of claim 28 and further comprising a mounting bracket that receives the operator device in order to position the transponder within a field of the antenna.

30. The system of claim 28 wherein the antenna includes a coil wrapped around a cylinder coupled to the button.

31. The system of claim 28 wherein the ignition switch is coupled to one of a throttle lever and a brake lever.

32. The system of claim 28 wherein the ignition switch is used to start an engine of the powersports vehicle and a kill switch is used to stop the engine of the powersports vehicle.

33. The system of claim 28 and further comprising a safety interlock device coupled to a seat of the powersports vehicle and electrically connected to the ignition switch.

34. The system of claim 28 wherein the powersports vehicle is one of an all-terrain vehicle, a snowmobile, a personal water craft, a boat, a motorcycle, a construction machine, and a lawn mower.

35. The system of claim 28 wherein the authorization system is not powered before the ignition switch is actuated, is powered when the ignition switch is actuated, and remains powered after the ignition switch is released until a change of state.

36. An operator device for use with an ignition system and a starting system of a powersports vehicle, the operator device comprising:
a transponder that receives and transmits a signal when in the presence of a field; and
at least one of a bladeless fob, a glove, a helmet, an article of clothing, and a ring coupled to the transponder and being positioned within a range of an antenna in order to verify the signal and start the powersports vehicle.

37. The device of claim 36 and further comprising a battery to power the transponder for a longer range of use from the antenna.

38. A transponder authorization system for use with a latch of a storage facility, the transponder authorization system comprising:
an operator device including a transponder;
a wake-up switch coupled to the storage facility;
an antenna coupled to the storage facility;
an authorization system electrically connected to the antenna and the wake-up switch; and
a button coupled to the wake-up switch;
the button actuating the wake-up switch when pushed by an operator, the authorization system sending a signal to the antenna, the antenna generating a field, the transponder receiving and transmitting a signal when in the presence of the field, and the authorization system verifying the signal in order to open the latch.

39. The system of claim 38 wherein the operator device includes one of a fob, a glove, a helmet, an article of clothing, and a ring.

40. The system of claim 38 wherein the operator device includes a battery to power the transponder for a longer range of use from the antenna.

41. The system of claim 38 wherein the antenna includes a coil wrapped around a cylinder coupled to the button.

42. The system of claim 38 and further comprising a mounting bracket coupled adjacent to the button in order to store an operator device including a bladeless fob.

43. The system of claim 38 wherein the authorization system is not powered before the wake-up switch is actuated, is powered when the wake-up switch is actuated, and remains powered after the wake-up switch is released until a change of state.
